(19) United States
(12) Patent Application Publication
(10) Pub. No.: US 2021/0385052 A1
(43) Pub. Date: Dec. 9, 2021

(54) ASYMMETRIC CARRIER BANDWIDTH DESIGN FOR WIRELESS COMMUNICATION SYSTEM

(71) Applicant: Telefonaktiebolaget LM Ericsson (publ), Stockholm (SE)

(72) Inventors: Yong Yao, Nanjing (CN); Shujun Li, Nanjing (CN); Wenyong Xu, Nanjing (CN); Yu Chen, Nanjing (CN)

(21) Appl. No.: 17/287,213

(22) PCT Filed: Oct. 15, 2019
(86) PCT No.: PCT/CN2019/111224

§ 371 Date: Apr. 21, 2021

(30) Foreign Application Priority Data
Oct. 22, 2018 (CN) PCT/CN2018/111247

(51) Int. Cl. H04L 5/00; H04W 56/00

(52) U.S. Cl. CPC H04L 5/0092; H04W 56/0035; H04L 5/0053; H04L 5/0046

(57) ABSTRACT

Various embodiments of the present disclosure provide methods and apparatuses for asymmetric carrier bandwidth design. The method implemented at a network node comprising determining a message comprising a delta carrier center frequency shift parameter. The method implemented at a network node further comprises transmitting the message to at least one terminal device.

### FIELD OF THE INVENTION

The present disclosure generally relates to communication networks, and more specifically, to determining a message comprising a delta carrier center frequency shift parameter and transmitting the message.

### BACKGROUND

This section introduces aspects that may facilitate a better understanding of the disclosure. Accordingly, the statements of this section are to be read in this light and are not to be understood as admissions about what is in the prior art or what is not in the prior art.

As mobile communication technology advances, there has been a growing consensus that spectrum is a one of the key components for wireless communication systems, such as new radio (NR) networks/fifth generation (5G) wireless system.

The operating bands and channel bandwidths for NR have been defined in 3GPP TS 38.101-1 V15.2.0. The frequency range (FR) 1 is 450 MHz-6000 MHz, and the FR2 is 24250 MHz-52600 MHz. The NR operating bands in FR1 are as follows:

TABLE 1
NR operating bands in FR1

| | Uplink (UL) | Downlink (DL) | |
|---|---|---|---|
| | operating band | operating band | |
| NR | BS receive/UE | BS transmit/UE | |
| operating | transmit FUL_low- | receive FDL_low- | Duplex |
| band | FUL_high | FDL_high | Mode |
| n1 | 1920 MHz- 1980 MHz | 2110 MHz-2170 MHz | FDD |
| n2 | 1850 MHz-1910 MHz | 1930 MHz-1990 MHz | FDD |
| n3 | 1710 MHz-1785 MHz | 1805 MHz-1880 MHz | FDD |
| n5 | 824 MHz-849 MHz | 869 MHz-894 MHz | FDD |
| n7 | 2500 MHz-2570 MHz | 2620 MHz-2690 MHz | FDD |
| n8 | 880 MHz-915 MHz | 925 MHz-960 MHz | FDD |
| n12 | 699 MHz-716 MHz | 729 MHz-746 MHz | FDD |
| n20 | 832 MHz-862 MHz | 791 MHz-821 MHz | FDD |
| n25 | 1850 MHz-1915 MHz | 1930 MHz-1995 MHz | FDD |
| n28 | 703 MHz-748 MHz | 758 MHz-803 MHz | FDD |
| n34 | 2010 MHz-2025 MHz | 2010 MHz-2025 MHz | TDD |
| n38 | 2570 MHz-2620 MHz | 2570 MHz-2620 MHz | TDD |
| n39 | 1880 MHz-1920 MHz | 1880 MHz-1920 MHz | TDD |
| n40 | 2300 MHz-2400 MHz | 2300 MHz-2400 MHz | TDD |
| n41 | 2496 MHz-2690 MHz | 2496 MHz-2690 MHz | TDD |
| n51 | 1427 MHz-1432 MHz | 1427 MHz-1432 MHz | TDD |
| n66 | 1710 MHz-1780 MHz | 2110 MHz-2200 MHz | FDD |
| n70 | 1695 MHz-1710 MHz | 1995 MHz-2020 MHz | FDD |
| n71 | 663 MHz-698 MHz | 617 MHz-652 MHz | FDD |
| n75 | N/A | 1432 MHz-1517 MHz | SDL |
| n76 | N/A | 1427 MHz-1432 MHz | SDL |
| n77 | 3300 MHz-4200 MHz | 3300 MHz-4200 MHz | TDD |
| n78 | 3300 MHz-3800 MHz | 3300 MHz-3800 MHz | TDD |
| n79 | 4400 MHz-5000 MHz | 4400 MHz-5000 MHz | TDD |
| n80 | 1710 MHz-1785 MHz | N/A | SUL |
| n81 | 880 MHz-915 MHz | N/A | SUL |
| n82 | 832 MHz-862 MHz | N/A | SUL |
| n83 | 703 MHz-748 MHz | N/A | SUL |
| n84 | 1920 MHz-1980 MHz | N/A | SUL |
| n86 | 1710 MHz-1780 MHz | N/A | SUL |

The user equipment (UE) channel bandwidth supports a single NR Radio frequency (RF) carrier in the uplink or downlink at the UE. From a base station (BS) perspective, different UE channel bandwidths may be supported within the same spectrum for transmitting to and receiving from UEs connected to the BS. Transmission of multiple carriers to the same UE or multiple carriers to different UEs within the BS channel bandwidth can be supported.

### SUMMARY

This summary is provided to introduce a selection of concepts in a simplified form that are further described below in the detailed description. This summary is not intended to identify key features or essential features of the claimed subject matter, nor is it intended to be used to limit the scope of the claimed subject matter.

According to the current specification, it is observed that the UE channel bandwidth can be asymmetric in downlink and uplink, but they are confined in the be below limited combination for the operating bands and supported asymmetric channel bandwidth:

TABLE 2
FDD asymmetric UL and DL channel bandwidth combinations

| | Channel bandwidths | Channel bandwidths |
|---|---|---|
| NR Band | for UL (MHz) | for DL (MHz) |
| n66 | 5, 10 | 20, 40 |
| | 20 | 40 |
| n70 | 5 | 10, 15 |
| | 5, 10, 15 | 20, 25 |

In FDD, the confinement is defined as a deviation to the default Tx-Rx carrier center frequency separation as following: ΔF_{TX-RX}=|(BW_{DL}−BW_{UL})/2|.

The present disclosure proposes a solution for asymmetric carrier bandwidth design, which will support more flexible combination for the operating bands and supported asymmetric channel bandwidth.

According to a first aspect of the present disclosure, there is provided a method implemented at a network node. The method comprises determining a message comprising a delta carrier center frequency shift parameter Δf. The method further comprises transmitting the message to at least one terminal device.

In accordance with an exemplary embodiment, the message may further comprise a bandwidth for uplink transmission BW_{UL} and/or downlink transmission BW_{DL}.

In accordance with an exemplary embodiment, the delta carrier center frequency shift parameter Δf may follow the restriction of: Δf<=|(BW_{DL}−BW_{UL})|/2, wherein the |⋅| is the absolute value, BW_{DL} is a bandwidth for downlink transmission, BW_{UL} is a bandwidth for uplink transmission.

In accordance with an exemplary embodiment, the delta carrier center frequency shift parameter Δf may be 0.

In accordance with an exemplary embodiment, the bandwidth for uplink transmission BW_{UL} may be larger than or less than the bandwidth for downlink transmission BW_{DL}.

In accordance with an exemplary embodiment, the message may comprise a Radio Resource Control, RRC, message.

In accordance with an exemplary embodiment, transmitting the message to at least one terminal device may further comprise: broadcasting the message to multiple terminal devices.

In accordance with an exemplary embodiment, the method may further comprise: receiving an indication, which indicates if the terminal device supports asymmetric uplink and downlink channel bandwidth, from the terminal device.

According to a second aspect of the present disclosure, there is provided an apparatus implemented in a network node. The apparatus comprises one or more processors and one or more memories comprising computer program codes. The one or more memories and the computer program codes are configured to, with the one or more processors, cause the apparatus at least to perform any step of the method according to the first aspect of the present disclosure.

According to a third aspect of the present disclosure, there is provided a computer-readable medium having computer program codes embodied thereon which, when executed on a computer, cause the computer to perform any step of the method according to the first aspect of the present disclosure.

According to a fourth aspect of the present disclosure, there is provided an apparatus implemented in a network node. The apparatus comprises a determining module and a transmitting module. In accordance with some exemplary embodiments, the determining module is operable to carry out at least the determining step of the method according to the first aspect of the present disclosure. The transmitting module is operable to carry out at least the transmitting step of the method according to the first aspect of the present disclosure.

According to a fifth aspect of the present disclosure, there is provided a method implemented at a terminal device. The method comprises: receiving a message comprising a delta carrier center frequency shift parameter Δf from a network node. The method further comprises: obtaining the delta carrier center frequency shift parameter Δf from the message.

In accordance with an exemplary embodiment, the message may further comprise a bandwidth for uplink transmission BW_{UL} and/or downlink transmission BW_{DL}.

In accordance with an exemplary embodiment, the delta carrier center frequency shift parameter Δf may follow the restriction of: Δf<=|(BW_{DL}−BW_{UL})|/2, wherein the |⋅| is the absolute value, BW_{DL} is a bandwidth for downlink transmission, BW_{UL} is a bandwidth for uplink transmission.

In accordance with an exemplary embodiment, the delta carrier center frequency shift parameter Δf may be 0.

In accordance with an exemplary embodiment, the bandwidth for uplink transmission BW_{UL} may be larger than or less than the bandwidth for downlink transmission BW_{DL}.

In accordance with an exemplary embodiment, the message may comprise a Radio Resource Control, RRC, message.

In accordance with an exemplary embodiment, the method may further comprise: obtaining the bandwidth for uplink transmission BW_{UL} and/or downlink transmission BW_{DL}.

In accordance with an exemplary embodiment, the method may further comprise: transmitting an indication, which indicates if the terminal device supports asymmetric uplink and downlink channel bandwidth, from the terminal device.

According to a sixth aspect of the present disclosure, there is provided an apparatus implemented in a terminal device. The apparatus comprises one or more processors and one or more memories comprising computer program codes. The one or more memories and the computer program codes are configured to, with the one or more processors, cause the apparatus at least to perform any step of the method according to the fifth aspect of the present disclosure.

According to a seventh aspect of the present disclosure, there is provided a computer-readable medium having computer program codes embodied thereon which, when executed on a computer, cause the computer to perform any step of the method according to the fifth aspect of the present disclosure.

According to an eighth aspect of the present disclosure, there is provided an apparatus implemented in a terminal device. The apparatus comprises a receiving module and an obtaining module. In accordance with some exemplary embodiments, the receiving module is operable to carry out at least the receiving step of the method according to the fifth aspect of the present disclosure. The obtaining module is operable to carry out at least the obtaining step of the method according to the fifth aspect of the present disclosure.

According to a ninth aspect of the present disclosure, there is provided a method implemented in a communication system which may include a host computer, a base station and a UE. The method may comprise providing user data at the host computer. Optionally, the method may comprise, at the host computer, initiating a transmission carrying the user data to the UE via a cellular network comprising the base station which may perform any step of the method according to the fifth aspect of the present disclosure.

According to a tenth aspect of the present disclosure, there is provided a communication system including a host computer. The host computer may comprise processing circuitry configured to provide user data, and a communication interface configured to forward the user data to a cellular network for transmission to a UE. The cellular network may comprise a base station having a radio interface and processing circuitry. The base station's processing circuitry may be configured to perform any step of the method according to the fifth aspect of the present disclosure.

According to an eleventh aspect of the present disclosure, there is provided a method implemented in a communication system which may include a host computer, a base station and a UE. The method may comprise providing user data at the host computer. Optionally, the method may comprise, at the host computer, initiating a transmission carrying the user data to the UE via a cellular network comprising the base station. The UE may perform any step of the method according to the first aspect of the present disclosure.

According to a twelfth aspect of the present disclosure, there is provided a communication system including a host computer. The host computer may comprise processing circuitry configured to provide user data, and a communication interface configured to forward user data to a cellular network for transmission to a UE. The UE may comprise a radio interface and processing circuitry. The UE's processing circuitry may be configured to perform any step of the method according to the first aspect of the present disclosure.

According to a thirteenth aspect of the present disclosure, there is provided a method implemented in a communication system which may include a host computer, a base station and a UE. The method may comprise, at the host computer, receiving user data transmitted to the base station from the UE which may perform any step of the method according to the first aspect of the present disclosure.

According to a fourteenth aspect of the present disclosure, there is provided a communication system including a host computer. The host computer may comprise a communication interface configured to receive user data originating from a transmission from a UE to a base station. The UE may comprise a radio interface and processing circuitry. The UE's processing circuitry may be configured to perform any step of the method according to the first aspect of the present disclosure.

According to a fifteenth aspect of the present disclosure, there is provided a method implemented in a communication system which may include a host computer, a base station and a UE. The method may comprise, at the host computer, receiving, from the base station, user data originating from a transmission which the base station has received from the UE. The base station may perform any step of the method according to the fifth aspect of the present disclosure.

According to a sixteenth aspect of the present disclosure, there is provided a communication system which may include a host computer. The host computer may comprise a communication interface configured to receive user data originating from a transmission from a UE to a base station. The base station may comprise a radio interface and processing circuitry. The base station's processing circuitry may be configured to perform any step of the method according to the fifth aspect of the present disclosure.

With above aspects of the present disclosure, the position of carrier center frequency is more flexible. According to some embodiments of the present invention, the bandwidth for UL/DL transmission is more flexible. According to some embodiments of the present invention, some non-standard carrier bandwidth or all 5G bandwidth of UL/DL may be supported.

### BRIEF DESCRIPTION OF THE DRAWINGS

The disclosure itself, the preferable mode of use and further objectives are best understood by reference to the following detailed description of the embodiments when read in conjunction with the accompanying drawings, in which:

FIG. 1 is a diagram illustrating an exemplary device architecture according to an embodiment of the present disclosure;

FIG. 2 is a flowchart illustrating a method according to some embodiments of the present disclosure;

FIGS. 3A-3C are diagrams respectively illustrating three exemplary uplink bandwidth and downlink bandwidth options according to some embodiments of the present disclosure;

FIG. 4 is a flowchart illustrating another method according to some embodiments of the present disclosure;

FIG. 5 is a block diagram illustrating an apparatus according to some embodiments of the present disclosure;

FIG. 6 is a block diagram illustrating another apparatus according to some embodiments of the present disclosure;

FIG. 7 is a block diagram illustrating yet another apparatus according to some embodiments of the present disclosure;

FIG. 8 is a block diagram illustrating a telecommunication network connected via an intermediate network to a host computer in accordance with some embodiments of the present disclosure;

FIG. 9 is a block diagram illustrating a host computer communicating via a base station with a UE over a partially wireless connection in accordance with some embodiments of the present disclosure;

FIG. 10 is a flowchart illustrating a method implemented in a communication system, in accordance with an embodiment of the present disclosure;

FIG. 11 is a flowchart illustrating a method implemented in a communication system, in accordance with an embodiment of the present disclosure;

FIG. 12 is a flowchart illustrating a method implemented in a communication system, in accordance with an embodiment of the present disclosure; and

FIG. 13 is a flowchart illustrating a method implemented in a communication system, in accordance with an embodiment of the present disclosure.

### DETAILED DESCRIPTION

The embodiments of the present disclosure are described in detail with reference to the accompanying drawings. It should be understood that these embodiments are discussed only for the purpose of enabling those skilled persons in the art to better understand and thus implement the present disclosure, rather than suggesting any limitations on the scope of the present disclosure. Reference throughout this specification to features, advantages, or similar language does not imply that all of the features and advantages that may be realized with the present disclosure should be or are in any single embodiment of the disclosure. Rather, language referring to the features and advantages is understood to mean that a specific feature, advantage, or characteristic described in connection with an embodiment is included in at least one embodiment of the present disclosure. Furthermore, the described features, advantages, and characteristics of the disclosure may be combined in any suitable manner in one or more embodiments. One skilled in the relevant art will recognize that the disclosure may be practiced without one or more of the specific features or advantages of a particular embodiment. In other instances, additional features and advantages may be recognized in certain embodiments that may not be present in all embodiments of the disclosure.

As used herein, the term “communication network” refers to a network following any suitable communication standards, such as new radio (NR), long term evolution (LTE), LTE-Advanced, wideband code division multiple access (WCDMA), high-speed packet access (HSPA), and so on. Furthermore, the communications between a terminal device and a network node in the communication network may be performed according to any suitable generation communication protocols, including, but not limited to, the first generation (1G), the second generation (2G), 2.5G, 2.75G, the third generation (3G), 4G, 4.5G, 5G communication protocols, and/or any other protocols either currently known or to be developed in the future.

The term “network node” refers to a network device in a communication network via which a terminal device accesses to the network and receives services therefrom. The network node may refer to a base station (BS), an access point (AP), a multi-cell/multicast coordination entity (MCE), a controller or any other suitable device in a wireless communication network. The BS may be, for example, a node B (NodeB or NB), an evolved NodeB (eNodeB or eNB), a next generation NodeB (gNodeB or gNB), a remote radio unit (RRU), a radio header (RH), a remote radio head (RRH), a relay, a low power node such as a femto, a pico, and so forth.

Yet further examples of the network node comprise multi-standard radio (MSR) radio equipment such as MSR BSs, network controllers such as radio network controllers (RNCs) or base station controllers (BSCs), base transceiver stations (BTSs), transmission points, transmission nodes, positioning nodes and/or the like. More generally, however, the network node may represent any suitable device (or group of devices) capable, configured, arranged, and/or operable to enable and/or provide a terminal device access to a wireless communication network or to provide some service to a terminal device that has accessed to the wireless communication network.

The term “terminal device” refers to any end device that can access a communication network and receive services therefrom. By way of example and not limitation, the terminal device may refer to a mobile terminal, a user equipment (UE), or other suitable devices. The UE may be, for example, a subscriber station, a portable subscriber station, a mobile station (MS) or an access terminal (AT). The terminal device may include, but not limited to, portable computers, image capture terminal devices such as digital cameras, gaining terminal devices, music storage and playback appliances, a mobile phone, a cellular phone, a smart phone, a tablet, a wearable device, a personal digital assistant (PDA), a vehicle, and the like. In the following description, terms “terminal device” and “UE” will be used interchangeably.

As yet another specific example, in an Internet of things (IoT) scenario, a terminal device may also be called an IoT device and represent a machine or other device that performs monitoring, sensing and/or measurements etc., and transmits the results of such monitoring, sensing and/or measurements etc. to another terminal device and/or a network equipment. The terminal device may in this case be a machine-to-machine (M2M) device, which may in a 3rd generation partnership project (3GPP) context be referred to as a machine-type communication (MTC) device.

As one particular example, the terminal device may be a UE implementing the 3GPP narrow band internet of things (NB-IoT) standard. Particular examples of such machines or devices are sensors, metering devices such as power meters, industrial machinery, or home or personal appliances, e.g. refrigerators, televisions, personal wearables such as watches etc. In other scenarios, a terminal device may represent a vehicle or other equipment, for example, a medical instrument that is capable of monitoring, sensing and/or reporting etc. on its operational status or other functions associated with its operation.

As used herein, the terms “first”, “second” and so forth refer to different elements. The singular forms “a” and “an” are intended to include the plural forms as well, unless the context clearly indicates otherwise. The terms “comprises”, “comprising”, “has”, “having”, “includes” and/or “including” as used herein, specify the presence of stated features, elements, and/or components and the like, but do not preclude the presence or addition of one or more other features, elements, components and/or combinations thereof. The term “based on” is to be read as “based at least in part on”. The term “one embodiment” and “an embodiment” are to be read as “at least one embodiment”. The term “another embodiment” is to be read as “at least one other embodiment”. Other definitions, explicit and implicit, may be included below.

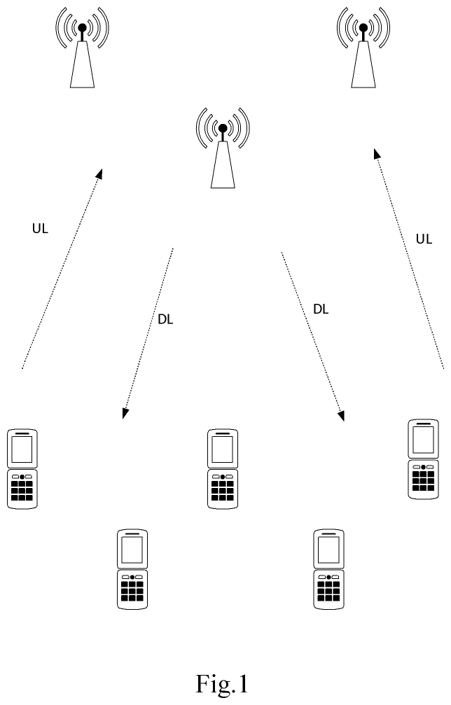

FIG. 1 is a diagram illustrating an exemplary device architecture according to an embodiment of the present disclosure. The diagram in FIG. 1 may represent a simplified architecture of a terminal device such as a UE which may be connected to a network node such as a base station in a wireless communication network. For simplicity, the device architecture of FIG. 1 only depicts some exemplary components such as the UE transmitting messages to the gNB using the uplink resources and gNB transmitting messages to the UE using the downlink resources. In practice, a terminal device according to some embodiments of the present disclosure may further include any additional elements or components suitable to support communication between the terminal device and a network node (such as a gNB) or another terminal device.

As shown in FIG. 1, the downlink (DL) is used for network node transmitting messages to UE, and the uplink (UL) is used for UE transmitting messages to network node. In most cases, the bandwidths for downlink and uplink are symmetrical, which means the bandwidths for downlink and uplink are basically the same, and the carrier center frequencies for downlink and uplink are aligned, such as n34 or n38, etc. NR operating band as described above.

According to the current specification, although the concept of asymmetric UL/DL are defined, but they are with strict limitation, which is not flexible.

Therefore, it's meaningful to provide more flexibility for the UL/DL carrier design, such as the carrier center frequency, in addition, the bandwidth for UL/DL transmission.

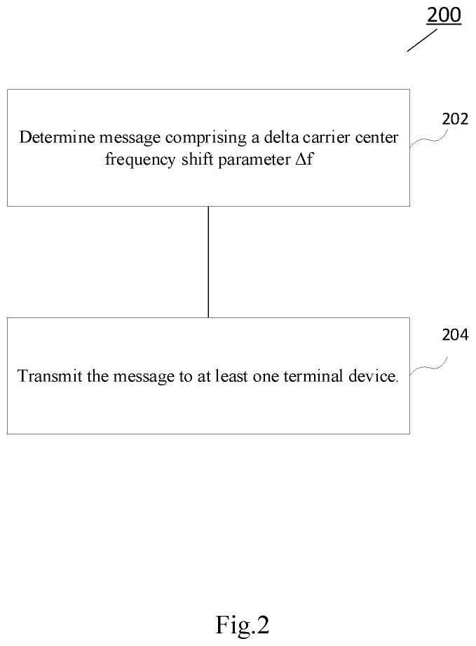

FIG. 2 is a flowchart illustrating a method 200 according to some embodiments of the present disclosure. The method 200 illustrated in FIG. 2 may be performed by an apparatus implemented in a network node or communicatively coupled to a network node.

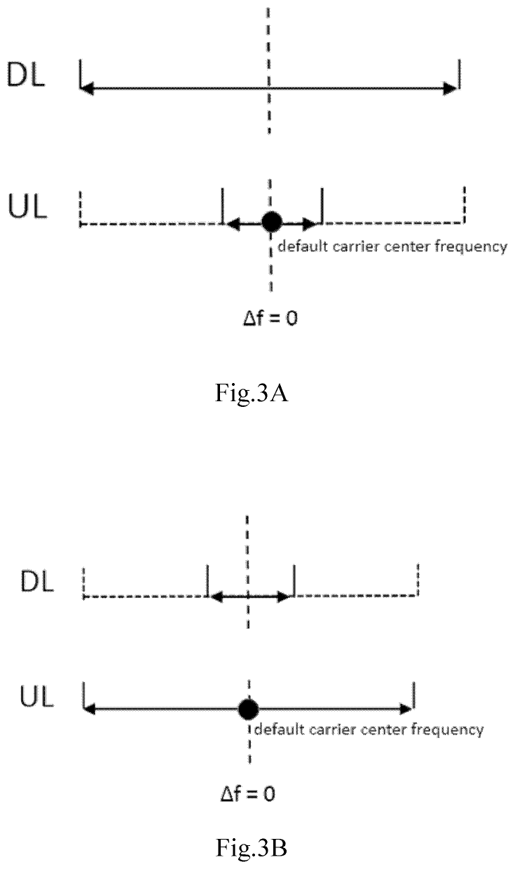

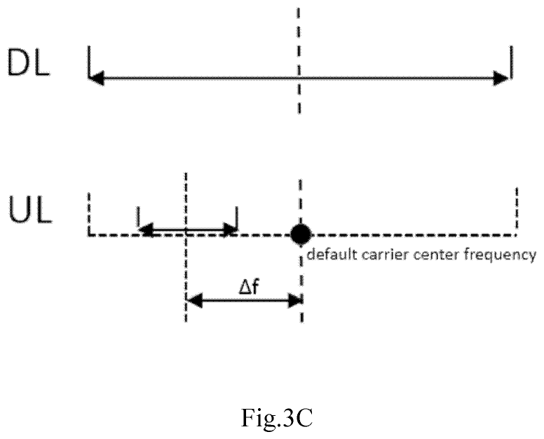

According to the exemplary method 200 illustrated in FIG. 2, the network node such as a gNB can determine a message comprising a delta carrier center frequency shift parameter Δf, as shown in block 202. The delta carrier center frequency shift parameter Δf may be the frequency shift between the default carrier center frequency of the UL and the actual carrier center frequency of the UL, which is shown in FIG. 3, especially FIG. 3C.

In some explementary embodiments, the central frequency for DL shouldn't be changed, and the Δf can be used to find the location of UL central frequency for UE transmission.

In some explementary embodiments, Carrier bandwidth notification to UE follows legacy method and message IE SCS-SpecificCarrier. The offset Δf can be notified to UE via a new IE in FrequencyInfoUL and FrequencyInfoUL-SIB IE.

According to the exemplary method 200 illustrated in FIG. 2, the network node such as a gNB can transmit the message to at least one terminal device, as shown in block 204, in order to let the terminal device know the carrier center frequency shift. Since the terminal device can get the default carrier center frequency for UL from the RRC message received from the network node, then the terminal device can get the carrier center frequency for UL by default carrier center frequency for UL plus or minus the delta carrier center frequency shift parameter Δf. In some embodiments, the transmitting could be broadcasting, which means the gNB can broadcast the message to multiple terminal device.

In accordance with an exemplary embodiment, the message further comprises a bandwidth for uplink transmission BW_{UL}.

In accordance with another exemplary embodiment, the message further comprises a bandwidth for downlink transmission BW_{DL}.

In accordance with another exemplary embodiment, the message further comprises a bandwidth for uplink transmission BW_{UL} and downlink transmission BW_{DL}.

According to some embodiments of the invention, the BW_{UL} and BW_{DL} can be the same or different, which provide more flexibility. And the terminal device can get the BW_{UL}, or the BW_{DL}, or the BW_{UL} and BW_{DL} from the message.

In accordance with an exemplary embodiment, the delta carrier center frequency shift parameter Δf follows the restriction of: Δf<=|(BW_{DL}−BW_{UL})|/2, wherein the |⋅| is the absolute value, BW_{DL} is a bandwidth for downlink transmission, BW_{UL} is a bandwidth for uplink transmission. Here, the Δf doesn't have to equal to |(BW_{DL}−BW_{UL})|/2, it can be any value equal to or less than |(BW_{DL}−BW_{UL})|/2, which also provide more flexibility. For certain circumstances, such as Carrier Aggregation (CA) or Coordinated multi-point operation (CoMP), this may be important, because CoMP and CA need to be flexibly asymmetric in downlink and uplink due to the asymmetric service between downlink and uplink. More specifically, the delta carrier center frequency shift parameter Δf can be 0, as shown in FIGS. 3A and 3B, which means there's no frequency shift between the actual carrier center frequency and the default carrier center frequency for UL received from the network node. The carrier center frequency for UL can be the default carrier center frequency for UL received from the network node.

In accordance with an exemplary embodiment, the bandwidth for uplink transmission BWᵤ may be larger than the bandwidth for downlink transmission BW_{DL}.

In accordance with an exemplary embodiment, the bandwidth for uplink transmission BW_{UL} may be less than the bandwidth for downlink transmission BW_{DL}.

Normally, the BW_{DL} may be less than BW_{DL}. But according to some embodiments of the invention, the BW_{UL} can also be larger than BW_{DL}.

In accordance with an exemplary embodiment, the message may be a Radio Resource Control, RRC, message, more specifically, the message may be an RRC SystemInformationBlockType1 (SIB1) message.

In accordance with an exemplary embodiment, the gNB may receive an indication, which indicates if the terminal device supports asymmetric uplink and downlink channel bandwidth, from the terminal device.

FIGS. 3A-3C are diagrams respectively illustrating three exemplary carrier bandwidth design options according to some embodiments of the present disclosure. The exemplary carrier bandwidth design options shown in FIGS. 3A-3C, may be provided to a network node such as a gNB. The solid line means the actual bandwidth, the dotted line is a reference for comparing the bandwidths.

According to FIG. 3A, the delta carrier center frequency shift parameter Δf is 0, which means there's no frequency shift between the actual carrier center frequency and the default carrier center frequency for UL received from the network node. The bandwidth for DL is larger than the bandwidth for UL.

Alternatively, the carrier bandwidth design can be shown as illustrated in FIG. 3B, in which the delta carrier center frequency shift parameter Δf is 0, which means there's no frequency shift between the actual carrier center frequency and the default carrier center frequency for UL received from the network node. The bandwidth for DL is less than the bandwidth for UL.

Alternatively, the carrier bandwidth design can be shown as illustrated in FIG. 3C, in which the delta carrier center frequency shift parameter Δf is not 0, which means there's frequency shift between the actual carrier center frequency and the default carrier center frequency for UL received from the network node. The bandwidth for DL is larger than the bandwidth for UL.

It will be appreciated that the carrier bandwidth designs in FIGS. 3A-3C are just shown as examples, and more or less alternative design options may be provisioned by the network node according to the embodiments of the present disclosure.

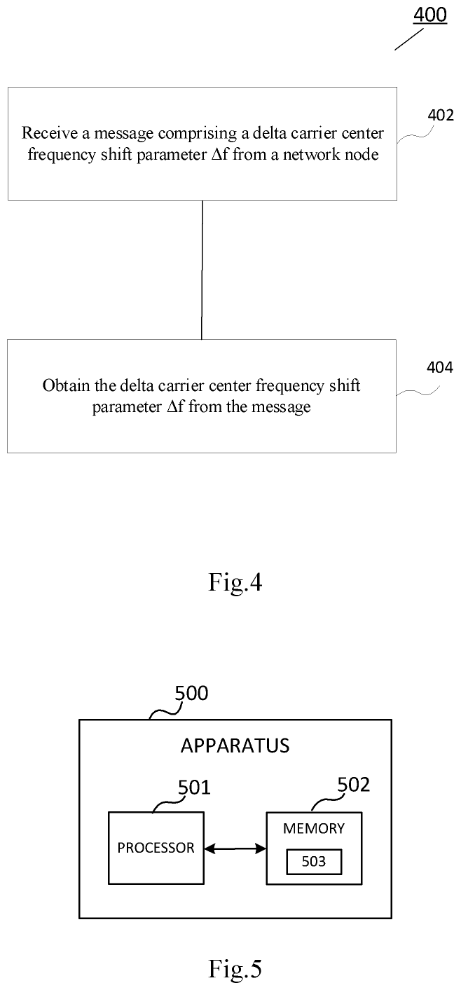

FIG. 4 is a flowchart illustrating a method 400 according to some embodiments of the present disclosure. As described in connection with FIG. 2, the method 400 illustrated in FIG. 4 may be performed by an apparatus implemented in a terminal device or communicatively coupled to a terminal device. In accordance with an exemplary embodiment, the terminal device such as a UE may a message comprising a delta carrier center frequency shift parameter Δf from a network node, as shown in block 402. The delta carrier center frequency shift parameter Δf may be the frequency shift between the default carrier center frequency of the UL and the actual carrier center frequency of the UL, which is shown in FIG. 3, especially FIG. 3C.

According to the exemplary method 400 illustrated in FIG. 4, the terminal device such as a UE can obtain the delta carrier center frequency shift parameter Δf from the message, as shown in block 204, in order to get the carrier center frequency shift. Since the terminal device can get the default carrier center frequency for UL from the RRC message received from the network node, then the terminal device can get the carrier center frequency for UL by default carrier center frequency for UL plus or minus the delta carrier center frequency shift parameter Δf.

In accordance with an exemplary embodiment, the message further comprises a bandwidth for uplink transmission BW_{UL}.

In accordance with another exemplary embodiment, the message further comprises a bandwidth for downlink transmission BW_{DL}.

In accordance with another exemplary embodiment, the message further comprises a bandwidth for uplink transmission BW_{UL} and downlink transmission BW_{DL}.

According to some embodiments of the invention, the BW_{UL} and BW_{DL} can be the same or different, which provide more flexibility. And the terminal device can get the BW_{UL}, BW_{DL}, BW_{UL} and BW_{DL} from the message.

In accordance with an exemplary embodiment, the delta carrier center frequency shift parameter Δf follows the restriction of: Δf<=|(BW_{DL}−BW_{UL})|/2, wherein the is the absolute value, BW_{DL} is a bandwidth for downlink transmission, BW_{UL} is a bandwidth for uplink transmission. Here, the Δf doesn't have to equal to |(BW_{DL}−BW_{UL})|/2, it can be any value equal to or less than |(BW_{DL}−BW_{UL})|/2, which also provide more flexibility. For certain circumstances, such as Carrier Aggregation (CA) or Coordinated multi-point operation (CoMP), this may be important, because CoMP and CA need to be flexibly asymmetric in downlink and uplink due to the asymmetric service between downlink and uplink. More specifically, the delta carrier center frequency shift parameter Δf can be 0, as shown in FIGS. 3A and 3B, which means there's no frequency shift between the actual carrier center frequency and the default carrier center frequency for UL received from the network node. The carrier center frequency for UL can be the default carrier center frequency for UL received from the network node.

In accordance with an exemplary embodiment, the bandwidth for uplink transmission BW_{UL} may be larger than the bandwidth for downlink transmission BW_{DL}.

In accordance with an exemplary embodiment, the bandwidth for uplink transmission BW_{UL} may be less than the bandwidth for downlink transmission BW_{DL}.

Normally, the BW_{UL} may be less than BW_{DL}. But according to some embodiments of the invention, the BW_{UL} can also be larger than BW_{DL}.

In accordance with an exemplary embodiment, the message may be a Radio Resource Control, RRC, message, more specifically, the message may be an RRC SystemInformationBlockType1 (SIB1) message.

In accordance with an exemplary embodiment, the terminal device may obtain the bandwidth for uplink transmission BW_{UL} and/or downlink transmission BW_{DL}.

In accordance with an exemplary embodiment, the terminal device may transmit an indication, which indicates if the terminal device supports asymmetric uplink and downlink channel bandwidth, from the terminal device.

The various blocks shown in FIG. 2 and FIG. 4 may be viewed as method steps, and/or as operations that result from operation of computer program code, and/or as a plurality of coupled logic circuit elements constructed to carry out the associated function(s). The schematic flow chart diagrams described above are generally set forth as logical flow chart diagrams. As such, the depicted order and labeled steps are indicative of specific embodiments of the presented methods. Other steps and methods may be conceived that are equivalent in function, logic, or effect to one or more steps, or portions thereof, of the illustrated methods. Additionally, the order in which a particular method occurs may or may not strictly adhere to the order of the corresponding steps shown.

FIG. 5 is a block diagram illustrating an apparatus 500 according to various embodiments of the present disclosure. As shown in FIG. 5, the apparatus 500 may comprise one or more processors such as processor 501, and one or more memories such as memory 502, storing computer program codes 503. The memory 502 may be non-transitory machine/processor/computer readable storage medium. In accordance with some exemplary embodiments, the apparatus 500 may be implemented as an integrated circuit chip or module that can be plugged or installed into a network node as described with respect to FIG. 2, and a terminal device as described with respect to FIG. 4.

In some implementations, the one or more memories 502, and the computer program codes 503, may be configured to, with the one or more processors 501, cause the apparatus 500 at least to perform any operation of the method as described in connection with FIG. 2 and FIG. 4. In other implementations, the one or more memories 502, and the computer program codes 503, may be configured to, with the one or more processors 501, cause the apparatus 500 at least to perform any operation of the method as described in connection with FIG. 2 and FIG. 4.

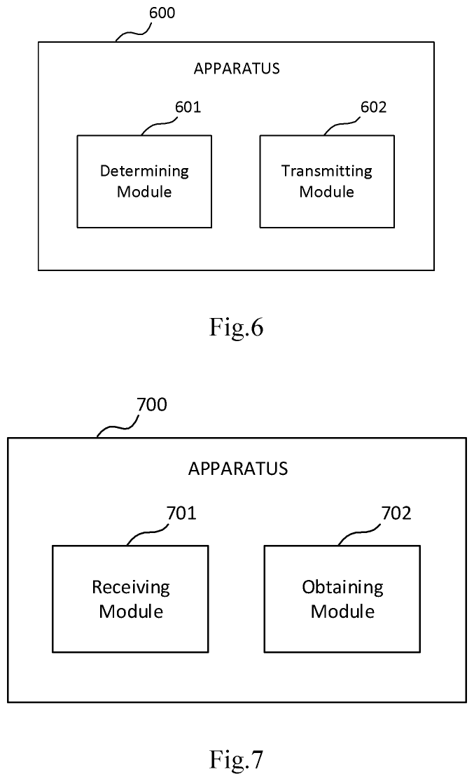

FIG. 6 is a block diagram illustrating an apparatus 600 according to some embodiments of the present disclosure. As shown in FIG. 6, the apparatus 600 may comprise a determining module 601 and a transmitting module 602. In an exemplary embodiment, the apparatus 600 may be implemented in a network node such as a gNB. The determining module 601 may be operable to carry out the operation in block 202, and the transmitting module 602 may be operable to carry out the operation in block 204. Optionally, the determining module 601 and/or the transmitting module 602 may be operable to carry out more or less operations to implement the proposed methods according to the exemplary embodiments of the present disclosure.

FIG. 7 is a block diagram illustrating an apparatus 700 according to some embodiments of the present disclosure. As shown in FIG. 7, the apparatus 700 may comprise a receiving module 701 and an obtaining module 702. In an exemplary embodiment, the apparatus 700 may be implemented in a terminal device such as a UE. The receiving module 701 may be operable to carry out the operation in block 402, and the obtaining module 702 may be operable to carry out the operation in block 404. Optionally, the receiving module 701 and/or the obtaining module 702 may be operable to carry out more or less operations to implement the proposed methods according to the exemplary embodiments of the present disclosure.

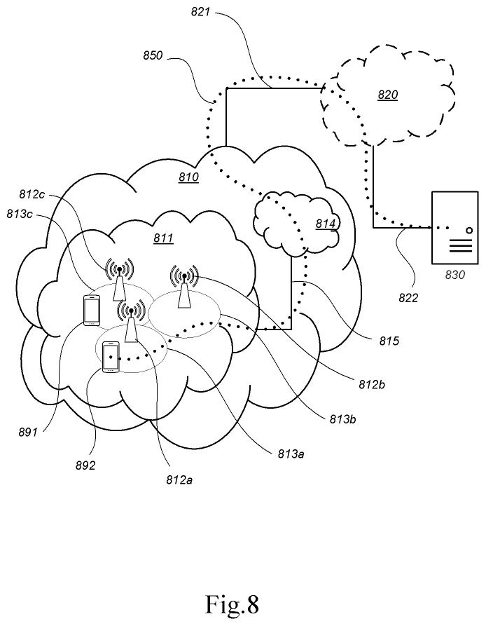

FIG. 8 is a block diagram illustrating a telecommunication network connected via an intermediate network to a host computer in accordance with some embodiments of the present disclosure.

With reference to FIG. 8, in accordance with an embodiment, a communication system includes a telecommunication network 810, such as a 3GPP-type cellular network, which comprises an access network 811, such as a radio access network, and a core network 814. The access network 811 comprises a plurality of base stations 812a, 812b, 812c, such as NBs, eNBs, gNBs or other types of wireless access points, each defining a corresponding coverage area 813a, 813b, 813c. Each base station 812a, 812b, 812c is connectable to the core network 814 over a wired or wireless connection 815. A first UE 881 located in a coverage area 813c is configured to wirelessly connect to, or be paged by, the corresponding base station 812c. A second UE 882 in a coverage area 813a is wirelessly connectable to the corresponding base station 812a. While a plurality of UEs 881, 882 are illustrated in this example, the disclosed embodiments are equally applicable to a situation where a sole UE is in the coverage area or where a sole UE is connecting to the corresponding base station 812.

The telecommunication network 810 is itself connected to a host computer 830, which may be embodied in the hardware and/or software of a standalone server, a cloud-implemented server, a distributed server or as processing resources in a server farm. The host computer 830 may be under the ownership or control of a service provider, or may be operated by the service provider or on behalf of the service provider. Connections 821 and 822 between the telecommunication network 810 and the host computer 830 may extend directly from the core network 814 to the host computer 830 or may go via an optional intermediate network 820. An intermediate network 820 may be one of, or a combination of more than one of, a public, private or hosted network; the intermediate network 820, if any, may be a backbone network or the Internet; in particular, the intermediate network 820 may comprise two or more sub-networks (not shown).

The communication system of FIG. 8 as a whole enables connectivity between the connected UEs 881, 882 and the host computer 830. The connectivity may be described as an over-the-top (OTT) connection 850. The host computer 830 and the connected UEs 881, 882 are configured to communicate data and/or signaling via the OTT connection 850, using the access network 811, the core network 814, any intermediate network 820 and possible further infrastructure (not shown) as intermediaries. The OTT connection 850 may be transparent in the sense that the participating communication devices through which the OTT connection 850 passes are unaware of routing of uplink and downlink communications. For example, the base station 812 may not or need not be informed about the past routing of an incoming downlink communication with data originating from the host computer 830 to be forwarded (e.g., handed over) to a connected UE 881. Similarly, the base station 812 need not be aware of the future routing of an outgoing uplink communication originating from the UE 881 towards the host computer 830.

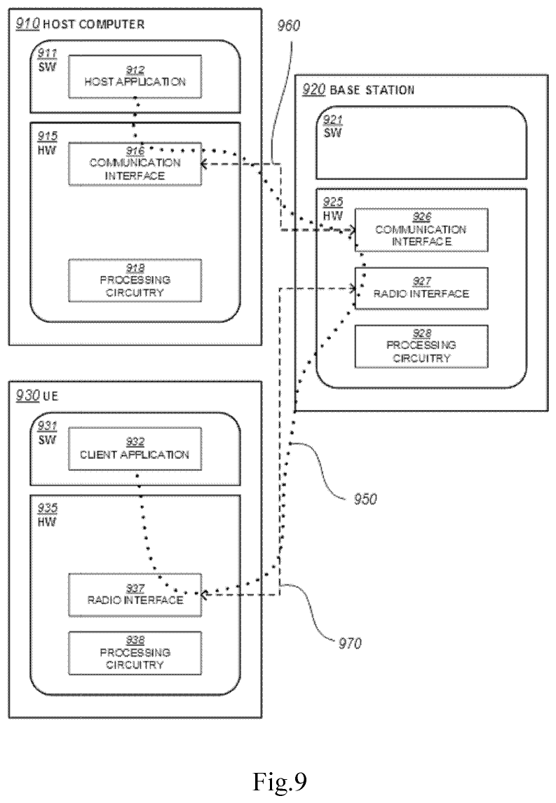

FIG. 9 is a block diagram illustrating a host computer communicating via a base station with a UE over a partially wireless connection in accordance with some embodiments of the present disclosure.

Example implementations, in accordance with an embodiment, of the UE, base station and host computer discussed in the preceding paragraphs will now be described with reference to FIG. 9. In a communication system 900, a host computer 99 comprises hardware 915 including a communication interface 916 configured to set up and maintain a wired or wireless connection with an interface of a different communication device of the communication system 900. The host computer 99 further comprises a processing circuitry 918, which may have storage and/or processing capabilities. In particular, the processing circuitry 918 may comprise one or more programmable processors, application-specific integrated circuits, field programmable gate arrays or combinations of these (not shown) adapted to execute instructions. The host computer 99 further comprises software 911, which is stored in or accessible by the host computer 99 and executable by the processing circuitry 918. The software 911 includes a host application 912. The host application 912 may be operable to provide a service to a remote user, such as UE 930 connecting via an OTT connection 950 terminating at the UE 930 and the host computer 99. In providing the service to the remote user, the host application 912 may provide user data which is transmitted using the OTT connection 950.

The communication system 900 further includes a base station 920 provided in a telecommunication system and comprising hardware 925 enabling it to communicate with the host computer 99 and with the UE 930. The hardware 925 may include a communication interface 926 for setting up and maintaining a wired or wireless connection with an interface of a different communication device of the communication system 900, as well as a radio interface 927 for setting up and maintaining at least a wireless connection 970 with the UE 930 located in a coverage area (not shown in FIG. 9) served by the base station 920. The communication interface 926 may be configured to facilitate a connection 960 to the host computer 99. The connection 960 may be direct or it may pass through a core network (not shown in FIG. 9) of the telecommunication system and/or through one or more intermediate networks outside the telecommunication system. In the embodiment shown, the hardware 925 of the base station 920 further includes a processing circuitry 928, which may comprise one or more programmable processors, application-specific integrated circuits, field programmable gate arrays or combinations of these (not shown) adapted to execute instructions. The base station 920 further has software 921 stored internally or accessible via an external connection.

The communication system 900 further includes the UE 930 already referred to. Its hardware 935 may include a radio interface 937 configured to set up and maintain a wireless connection 970 with a base station serving a coverage area in which the UE 930 is currently located. The hardware 935 of the UE 930 further includes a processing circuitry 938, which may comprise one or more programmable processors, application-specific integrated circuits, field programmable gate arrays or combinations of these (not shown) adapted to execute instructions. The UE 930 further comprises software 931, which is stored in or accessible by the UE 930 and executable by the processing circuitry 938. The software 931 includes a client application 932. The client application 932 may be operable to provide a service to a human or non-human user via the UE 930, with the support of the host computer 99. In the host computer 99, an executing host application 912 may communicate with the executing client application 932 via the OTT connection 950 terminating at the UE 930 and the host computer 99. In providing the service to the user, the client application 932 may receive request data from the host application 912 and provide user data in response to the request data. The OTT connection 950 may transfer both the request data and the user data. The client application 932 may interact with the user to generate the user data that it provides.

It is noted that the host computer 99, the base station 920 and the UE 930 illustrated in FIG. 9 may be similar or identical to the host computer 930, one of base stations 912a, 912b, 912c and one of UEs 991, 992 of FIG. 9, respectively. This is to say, the inner workings of these entities may be as shown in FIG. 9 and independently, the surrounding network topology may be that of FIG. 9.

In FIG. 9, the OTT connection 950 has been drawn abstractly to illustrate the communication between the host computer 99 and the UE 930 via the base station 920, without explicit reference to any intermediary devices and the precise routing of messages via these devices. Network infrastructure may determine the routing, which it may be configured to hide from the UE 930 or from the service provider operating the host computer 99, or both. While the OTT connection 950 is active, the network infrastructure may further take decisions by which it dynamically changes the routing (e.g., on the basis of load balancing consideration or reconfiguration of the network).

Wireless connection 970 between the UE 930 and the base station 920 is in accordance with the teachings of the embodiments described throughout this disclosure. One or more of the various embodiments improve the performance of OTT services provided to the UE 930 using the OTT connection 950, in which the wireless connection 970 forms the last segment. More precisely, the teachings of these embodiments may improve the latency and the power consumption, and thereby provide benefits such as lower complexity, reduced time required to access a cell, better responsiveness, extended battery lifetime, etc.

A measurement procedure may be provided for the purpose of monitoring data rate, latency and other factors on which the one or more embodiments improve. There may further be an optional network functionality for reconfiguring the OTT connection 950 between the host computer 99 and the UE 930, in response to variations in the measurement results. The measurement procedure and/or the network functionality for reconfiguring the OTT connection 950 may be implemented in software 911 and hardware 915 of the host computer 99 or in software 931 and hardware 935 of the UE 930, or both. In embodiments, sensors (not shown) may be deployed in or in association with communication devices through which the OTT connection 950 passes; the sensors may participate in the measurement procedure by supplying values of the monitored quantities exemplified above, or supplying values of other physical quantities from which the software 911, 931 may compute or estimate the monitored quantities. The reconfiguring of the OTT connection 950 may include message format, retransmission settings, preferred routing etc.; the reconfiguring need not affect the base station 920, and it may be unknown or imperceptible to the base station 920. Such procedures and functionalities may be known and practiced in the art. In certain embodiments, measurements may involve proprietary UE signaling facilitating the host computer 99's measurements of throughput, propagation times, latency and the like. The measurements may be implemented in that the software 911 and 931 causes messages to be transmitted, in particular empty or ‘dummy’ messages, using the OTT connection 950 while it monitors propagation times, errors etc.

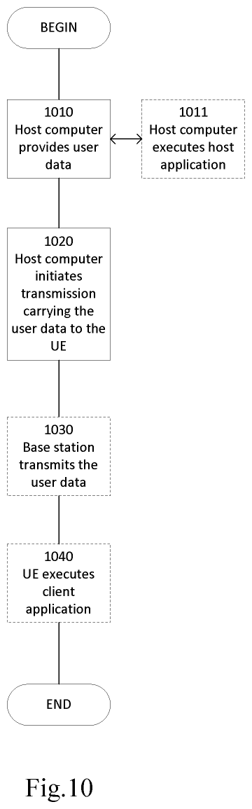

FIG. 10 is a flowchart illustrating a method implemented in a communication system, in accordance with an embodiment. The communication system includes a host computer, a base station and a UE which may be those described with reference to FIG. 9 and FIG. 10. For simplicity of the present disclosure, only drawing references to FIG. 10 will be included in this section. In step 1010, the host computer provides user data. In substep 1010 (which may be optional) of step 1010, the host computer provides the user data by executing a host application. In step 1020, the host computer initiates a transmission carrying the user data to the UE. In step 1030 (which may be optional), the base station transmits to the UE the user data which was carried in the transmission that the host computer initiated, in accordance with the teachings of the embodiments described throughout this disclosure. In step 1040 (which may also be optional), the UE executes a client application associated with the host application executed by the host computer.

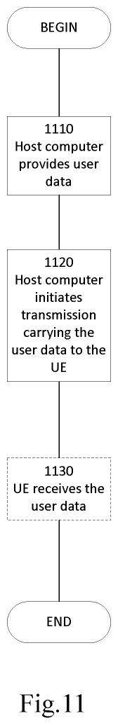

FIG. 11 is a flowchart illustrating a method implemented in a communication system, in accordance with an embodiment. The communication system includes a host computer, a base station and a UE which may be those described with reference to FIG. 9 and FIG. 10. For simplicity of the present disclosure, only drawing references to FIG. 11 will be included in this section. In step 1110 of the method, the host computer provides user data. In an optional substep (not shown) the host computer provides the user data by executing a host application. In step 1120, the host computer initiates a transmission carrying the user data to the UE. The transmission may pass via the base station, in accordance with the teachings of the embodiments described throughout this disclosure. In step 1130 (which may be optional), the UE receives the user data carried in the transmission.

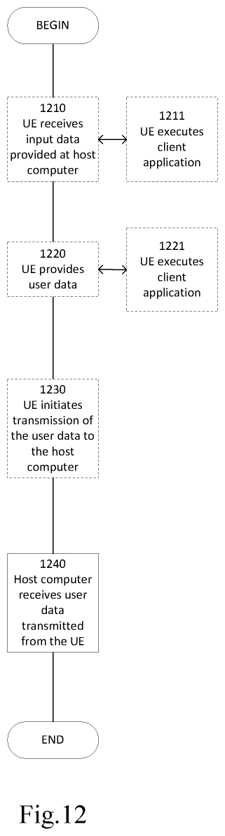

FIG. 12 is a flowchart illustrating a method implemented in a communication system, in accordance with an embodiment. The communication system includes a host computer, a base station and a UE which may be those described with reference to FIG. 9 and FIG. 10. For simplicity of the present disclosure, only drawing references to FIG. 12 will be included in this section. In step 1210 (which may be optional), the UE receives input data provided by the host computer. Additionally or alternatively, in step 1220, the UE provides user data. In substep 1221 (which may be optional) of step 1220, the UE provides the user data by executing a client application. In substep 1211 (which may be optional) of step 1210, the UE executes a client application which provides the user data in reaction to the received input data provided by the host computer. In providing the user data, the executed client application may further consider user input received from the user. Regardless of the specific manner in which the user data was provided, the UE initiates, in substep 1230 (which may be optional), transmission of the user data to the host computer. In step 1240 of the method, the host computer receives the user data transmitted from the UE, in accordance with the teachings of the embodiments described throughout this disclosure.

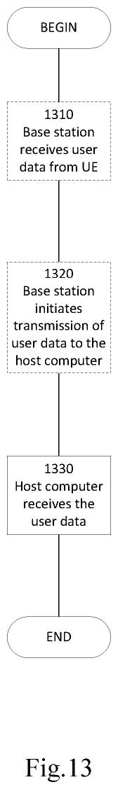

FIG. 13 is a flowchart illustrating a method implemented in a communication system, in accordance with an embodiment. The communication system includes a host computer, a base station and a UE which may be those described with reference to FIG. 9 and FIG. 10. For simplicity of the present disclosure, only drawing references to FIG. 13 will be included in this section. In step 1310 (which may be optional), in accordance with the teachings of the embodiments described throughout this disclosure, the base station receives user data from the UE. In step 1320 (which may be optional), the base station initiates transmission of the received user data to the host computer. In step 1330 (which may be optional), the host computer receives the user data carried in the transmission initiated by the base station.

In general, the various exemplary embodiments may be implemented in hardware or special purpose chips, circuits, software, logic or any combination thereof. For example, some aspects may be implemented in hardware, while other aspects may be implemented in firmware or software which may be executed by a controller, microprocessor or other computing device, although the disclosure is not limited thereto. While various aspects of the exemplary embodiments of this disclosure may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

As such, it should be appreciated that at least some aspects of the exemplary embodiments of the disclosure may be practiced in various components such as integrated circuit chips and modules. It should thus be appreciated that the exemplary embodiments of this disclosure may be realized in an apparatus that is embodied as an integrated circuit, where the integrated circuit may comprise circuitry (as well as possibly firmware) for embodying at least one or more of a data processor, a digital signal processor, baseband circuitry and radio frequency circuitry that are configurable so as to operate in accordance with the exemplary embodiments of this disclosure.

It should be appreciated that at least some aspects of the exemplary embodiments of the disclosure may be embodied in computer-executable instructions, such as in one or more program modules, executed by one or more computers or other devices. Generally, program modules include routines, programs, objects, components, data structures, etc. that perform particular tasks or implement particular abstract data types when executed by a processor in a computer or other device. The computer executable instructions may be stored on a computer readable medium such as a hard disk, optical disk, removable storage media, solid state memory, random access memory (RAM), etc. As will be appreciated by one of skill in the art, the function of the program modules may be combined or distributed as desired in various embodiments. In addition, the function may be embodied in whole or partly in firmware or hardware equivalents such as integrated circuits, field programmable gate arrays (FPGA), and the like.

The present disclosure includes any novel feature or combination of features disclosed herein either explicitly or any generalization thereof. Various modifications and adaptations to the foregoing exemplary embodiments of this disclosure may become apparent to those skilled in the relevant arts in view of the foregoing description, when read in conjunction with the accompanying drawings. However, any and all modifications will still fall within the scope of the non-limiting and exemplary embodiments of this disclosure.

1. A method implemented at a network node, comprising:
determining a message comprising a delta carrier center frequency shift parameter Δf; and
transmitting the message to at least one terminal device.

2. The method according to claim 1, wherein the message further comprises a bandwidth for uplink transmission BW_{UL} and/or downlink transmission BW_{DL}.

3. The method according to claim 1, wherein the delta carrier center frequency shift parameter Δf follows the restriction of: Δf<=|(BW_{DL}−BW_{UL})|/2, wherein the |⋅| is the absolute value, BW_{DL} is a bandwidth for downlink transmission, BW_{UL} is a bandwidth for uplink transmission.

4. The method according to claim 1, wherein the delta carrier center frequency shift parameter Δf is 0.

5. The method according to claim 1, wherein the bandwidth for uplink transmission BW_{UL} is larger than or less than the bandwidth for downlink transmission BW_{DL}.

6. The method according to claim 1, wherein the message comprises a Radio Resource Control, RRC, message.

7. The method according to claim 1, wherein transmitting the message to at least one terminal device further comprises:
broadcasting the message to multiple terminal devices.

8. The method according to claim 1, further comprising:
receiving an indication, which indicates if the terminal device supports asymmetric uplink and downlink channel bandwidth, from the terminal device.

9. (canceled)

10. (canceled)

11. A method implemented at a terminal device, comprising:
receiving a message comprising a delta carrier center frequency shift parameter Δf from a network node; and
obtaining the delta carrier center frequency shift parameter Δf from the message.

12. The method according to claim 11, wherein the message further comprises a bandwidth for uplink transmission BW_{UL} and/or downlink transmission BW_{DL}.

13. The method according to claim 11, wherein the delta carrier center frequency shift parameter Δf follows the restriction of: Δf<=|(BW_{DL}−BW_{UL})|/2, wherein the |⋅| is the absolute value, BW_{DL} is a bandwidth for downlink transmission, BW_{UL} is a bandwidth for uplink transmission.

14. The method according to claim 11, wherein the delta carrier center frequency shift parameter Δf is 0.

15. The method according to claim 11, wherein the bandwidth for uplink transmission BW_{UL} is larger than or less than the bandwidth for downlink transmission BW_{DL}.

16. The method according to claim 11, wherein the message comprises a Radio Resource Control, RRC, message.

17. The method according to claim 12, further comprising:
obtaining the bandwidth for uplink transmission BW_{UL} and/or downlink transmission BW_{DL}.

18. The method according to claim 11, further comprising:
transmitting an indication, which indicates if the terminal device supports asymmetric uplink and downlink channel bandwidth, to the network node.

19. An apparatus implemented in a terminal device, comprising:
one or more processors; and
one or more memories comprising computer program codes,
the one or more memories and the computer program codes configured to, with the one or more processors, cause the apparatus at least to:
receive a message comprising a delta carrier center frequency shift parameter Δf from a network node; and
obtain the delta carrier center frequency shift parameter Δf from the message.

20-24. (canceled)

25. A non-transitory computer-readable storage medium comprising a computer program product including instructions to cause at least one processor to:
receive a message comprising a delta carrier center frequency shift parameter Δf from a network node; and
obtain the delta carrier center frequency shift parameter Δf from the message.
